(19) United States
(12) Patent Application Publication
(10) Pub. No.: US 2018/0348949 A1
(43) Pub. Date: Dec. 6, 2018

(54) TOUCH CONTROLLER FOR DRIVING TOUCH SCREEN INCLUDING FINGERPRINT SENSING ARRAY, DRIVING INTEGRATED CIRCUIT, AND METHOD OF OPERATING TOUCH SCREEN DEVICE INCLUDING THE SAME

(71) Applicant: SAMSUNG ELECTRONICS CO., LTD., Suwon-si (KR)

(72) Inventors: Sun-kwon KIM, Yongin-si (KR); Yoon-Kyung CHOI, Seoul (KR); Min-gyu KIM, Seongnam-si (KR); Seong-il PARK, Hwaseong-si (KR)

(73) Assignee: SAMSUNG ELECTRONICS CO., LTD., Suwon-si (KR)

(21) Appl. No.: 15/870,386

(22) Filed: Jan. 12, 2018

(30) Foreign Application Priority Data
Jun. 2, 2017 (KR) 10-2017-0069277
Nov. 20, 2017 (KR) 10-2017-0154974

(51) Int. Cl. G06F 3/041; G06K 9/00; G06F 3/044

(52) U.S. Cl. CPC G06F 3/0416; G06F 2203/04112; G06F 3/044; G06K 9/0002

(57) ABSTRACT

A touch controller for driving a touch screen including a touch sensing array and a fingerprint sensing array, the touch controller including a processor configured to: generate first touch data from a first input, on a touch sensing area of the touch screen, sensed by the touch sensing array; generate second touch data from a second input, on a fingerprint sensing area of the touch screen, sensed by at least one of the touch sensing array and the fingerprint sensing array; and compensate the second touch data by adjusting touch values included therein to generate compensated second touch data, wherein the first touch data, the second touch data and the compensated second touch data are used to calculate coordinates of the first input and the second input on the touch screen, and the fingerprint sensing array receives a third input on the fingerprint sensing area to generate fingerprint data.

### CROSS-REFERENCE TO THE RELATED APPLICATIONS

This application claims priority from Korean Patent Application No. 10-2017-0069277 filed on Jun. 2, 2017, and Korean Patent Application No. 10-2017-0154974 filed on Nov. 20, 2017, in the Korean Intellectual Property Office, the disclosures of which are incorporated herein in its entirety by reference.

### BACKGROUND

Apparatuses and methods consistent with exemplary embodiments of the inventive concept relate to a driving integrated circuit, and more particularly, to a touch controller for driving a touch screen including a fingerprint sensing array, a touch screen driving device circuit, and a method of operating a touch screen device including the same.

Recently, as wired/wireless communication technology and smart device-related technology advance rapidly, a method of using a fingerprint of a user is being widely used for performing user authentication corresponding to a security method enabling the safe use of the technologies. In mobile devices such as smartphones and tablet personal computers (PCs), on-display fingerprint sensing arrays combined with a touch screen (or a display) are needed for the convenience of use and the optimization of a size.

### SUMMARY

The inventive concept provides a touch screen device including a fingerprint sensor, in which touch sensing Exemplary embodiments of the inventive concept are based on a technology for accurate detection or sensing of touch coordinates of touch inputs on a touch screen device. Various aspects of the inventive concept will be set forth in part in the description which follows and, in part, will be apparent from the description, or may be learned by practice of the presented exemplary embodiments.

an exemplary embodiment, there is provided a touch controller for driving a touch screen including a touch sensing array and a fingerprint sensing array. The touch controller may include a processor configured to: generate first touch data from a first input, on a touch sensing area of the touch screen, which is sensed by the touch sensing array; generate second touch data from a second input, on a fingerprint sensing area of the touch screen, which is sensed by at least one of the touch sensing array and the fingerprint sensing array; and compensate the second touch data by adjusting touch values included therein to generate compensated second touch data. The first touch data, the second touch data and the compensated second touch data may be used to calculate first input coordinates of the first input and second input coordinates of the second input on the touch screen, and the fingerprint sensing array may be configured to receive a third input on the fingerprint sensing area to generate fingerprint data or a fingerprint image.

an aspect of an exemplary embodiment, there is provided fingerprint controller for driving a fingerprint sensing array connectable to a touch controller and a touch screen on which a touch sensing area and a fingerprint sensing area are provided. The fingerprint controller may include: a controller configured to generate first touch data from a first input on the fingerprint sensing area sensed by the fingerprint sensing array, transmit the first touch data to the touch controller, and generate fingerprint data from a fingerprint input on the fingerprint sensing area. Here, the first touch data may be used by the touch controller to generate position data of the first input on the touch screen.

an aspect of an exemplary embodiment, there is provided a touch screen device which may include: a touch screen including a touch sensing area and a fingerprint sensing area; a touch sensing array configured to sense a first input on at least one of the touch sensing area and the fingerprint sensing area in a touch sensing mode; a fingerprint sensing array disposed above or below the touch sensing array, configured to sense a second input on the fingerprint sensing area in the touch sensing mode, and configured to sense a third input on the fingerprint sensing area to generate a fingerprint image in a fingerprint sensing mode; and a processor configured to drive the touch sensing array and the fingerprint sensing array, generate first touch data from the first input, and generate second touch data from the second input. Here, the first touch data and the second touch data may be used to calculate first input coordinates of the first input and second input coordinates of the second input on the touch screen.

an aspect of an exemplary embodiment, there is provided a method of controlling a touch screen device which includes a touch screen, a touch sensing array and a fingerprint sensing array. The method may include: generating first touch data from a first input, on a touch sensing area of the touch screen, which is sensed by the touch sensing array; generating second touch data from a second input, on a fingerprint sensing area of the touch screen, which is sensed by at least one of the touch sensing array and the fingerprint sensing array; and compensating the second touch data by adjusting touch values included therein to generate compensated second touch data. Here, the first touch data, the second touch data and the compensated second touch data may be used to calculate first input coordinates of the first input and second input coordinates of the second input on the touch screen, and the fingerprint sensing array may be configured to receive a third input on the fingerprint sensing area to generate fingerprint data or a fingerprint image.

### BRIEF DESCRIPTION OF THE DRAWINGS

Exemplary embodiments of the inventive concept will be more clearly understood from the following detailed description taken in conjunction with the accompanying drawings, in which:

FIG. 1 illustrates a touch screen device according to an exemplary embodiment;

FIG. 2 is a vertical cross-sectional view taken along line A-A′ of a touch screen of FIG. 1, according to an exemplary embodiment;

FIG. 3 is a diagram for describing a touch sensing mode operation of a touch screen device, according to an exemplary embodiment;

FIGS. 4A and 4B illustrate implementation examples of a touch sensing array;

FIG. 5 illustrates an implementation example of a fingerprint sensing array;

FIG. 6 is a block diagram illustrating a driving integrated circuit according to an exemplary embodiment;

FIG. 7 is a block diagram illustrating a touch controller according to an exemplary embodiment;

FIG. 8 is a block diagram illustrating a fingerprint controller according exemplary to an embodiment;

FIG. 9 is a diagram for exemplarily describing a sensing resolution of a touch sensing array and a sensing resolution of a fingerprint sensing array;

FIGS. 10A to 10C are diagrams illustrating a method of calculating, by using a touch controller, touch coordinates by using first touch data and compensated second touch data, according to exemplary embodiments;

FIG. 11 is a flowchart illustrating a touch sensing method according to an exemplary embodiment;

FIGS. 12A to 12C are timing diagrams of a fingerprint controller and a touch controller based on the touch sensing method of FIG. 11, according to exemplary embodiments;

FIG. 13 is a diagram illustrating an operation of a fingerprint controller in a touch sensing method according to an embodiment;

FIGS. 14A to 14D illustrate methods of transmitting, by using a fingerprint controller, second touch data to a touch controller, according to exemplary embodiments; and

FIG. 15 is a diagram illustrating a smartphone according to an exemplary embodiment.

### DETAILED DESCRIPTION OF THE EXEMPLARY EMBODIMENTS

Various exemplary embodiments of the inventive concept will be described more fully hereinafter with reference to the accompanying drawings. The inventive concept may, however, be embodied in many different forms and should not be construed as limited to the exemplary embodiments set forth herein. Rather, these exemplary embodiments are provided so that this description will be thorough and complete, and will fully convey the scope of the inventive concept to those skilled in the art. In the drawings, the sizes and relative sizes of layers and regions may be exaggerated for clarity.

It will be understood that when an element or layer is referred to as being “over,” “above,” “on,” “connected to” or “coupled to” another element or layer, it can be directly over, above, on, connected or coupled to the other element or layer or intervening elements or layers may be present. In contrast, when an element is referred to as being “directly over,” “directly above,” “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “over,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, the exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, when an exemplary embodiment can be implemented differently, functions or operations described in a particular block may occur in a different way from a flow described in the flowchart. For example, two consecutive blocks may be performed simultaneously, or the blocks may be performed in reverse according to related functions or operations.

Hereinafter, exemplary embodiments will be described with reference to the accompanying drawings.

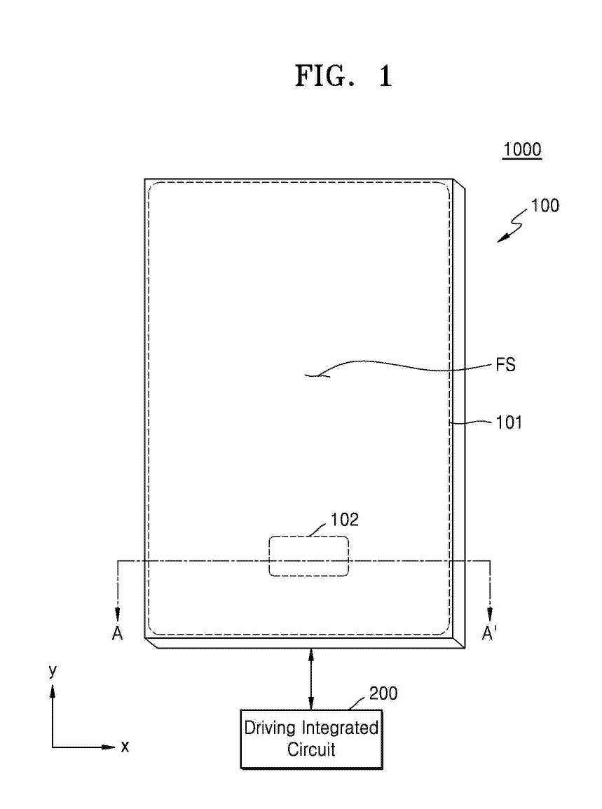

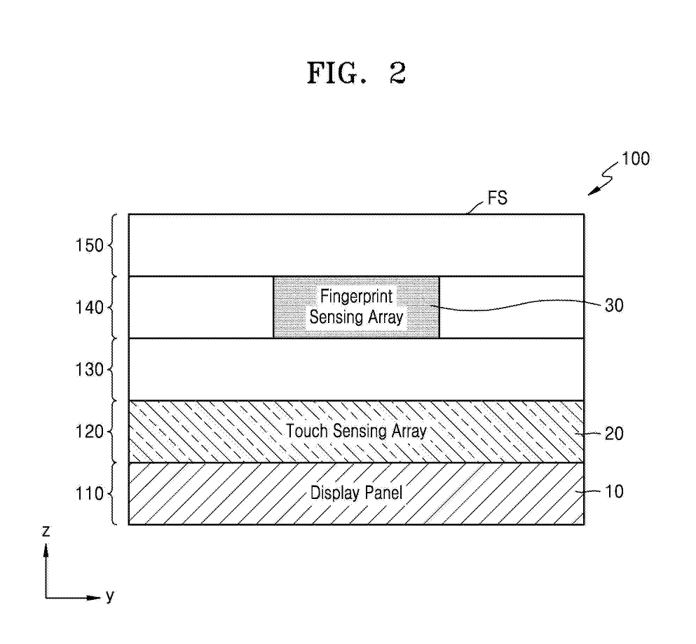

FIG. 1 illustrates a touch screen device according to an exemplary embodiment, and FIG. 2 is a vertical cross-sectional view taken along line A-A′ of a touch screen of FIG. 1, according to an exemplary embodiment.

The A touch screen device 1000 according to an exemplary embodiment may be implemented with a laptop computer, a mobile phone, a smartphone, a tablet PC, a personal digital assistant (PDA), an enterprise digital assistant (EDA), a digital still camera, a digital video camera, a portable multimedia player (PMP), a personal navigation device or portable navigation device (PND), a handheld game console, a mobile internet device (MID), an Internet of things (IoT) device, an Internet of everything (IoE) device, a drone, an e-book, or the like, but is not limited thereto. In other exemplary embodiments, the touch screen device 1000 may be an electronic device having a display function, a touch recognition function, and a fingerprint recognition function.

Referring to FIG. 1, the touch screen device 1000 may include a touch screen 100 and a driving integrated circuit 200. The touch screen device 1000 may further include other elements, and for example, when the touch screen device 1000 is a mobile device, the touch screen device 1000 may further include an application processor (AP).

The touch screen 100 may perform display, touch sensing, and fingerprint sensing to operate as an input/output (I/O) device of the touch screen device 1000. In an exemplary embodiment, the touch screen 100 may sense a force of a touch input. The touch screen 100 may be referred to as a touch screen panel, a touch screen stack, or a display stack.

The touch screen 100 may display an image, and may sense a touch input applied to the touch screen 100. When a finger of a user contacts or approximates the touch screen 100, the touch screen 100 may sense a fingerprint of the user. The touch input may include, for example, an object such as a finger directly contacting the touch screen 100, and moreover, the object placed in close proximity to the touch screen 100. Hereinafter, an object which enables a user to apply the touch input to the touch screen 100 may be referred to as an object, and the term “touch” may be defined as including “a proximity touch”. For example, the object may be a finger, a palm, a touch pen, a stylus pen, or the like, but is not limited thereto, and the touch input and sensing herebelow are referred to as including proximity input and sensing, respectively.

The touch screen 100 may include a touch sensing area 101 and a fingerprint sensing area 102. The touch sensing area 101 may be an area where a touch input is generated, and a position of a touch input is detected when the touch input is generated. In other words, in the touch sensing area 101, touch sensing may be performed. The touch sensing area 101 may be substantially the same as a display area, and may be a portion or a whole portion of a front surface FS (and a rear surface opposite to the front surface FS) of the touch screen 100. A touch sensing array may be disposed in the touch sensing area 101. The touch sensing array may be stacked on a display panel or be implemented as one body with the display panel.

The fingerprint sensing area 102 is an area where an image corresponding to an object, such as a fingerprint image, is captured when a touch input is made. As illustrated in FIG. 1, the fingerprint sensing area 102 may overlap with a part of the touch sensing area 101. In other words, the fingerprint sensing area 102 may be a part of the touch sensing area 101. Accordingly, fingerprint sensing as well as touch sensing may be performed in the fingerprint sensing area 102. In FIG. 1, one fingerprint sensing area 102 is illustrated, but the present embodiment is not limited thereto. In other exemplary embodiments, the fingerprint sensing area 102 may be provided in plurality, and thus, a plurality of fingerprint sensing areas may overlap the touch sensing area 101. A fingerprint sensing array may be disposed in the fingerprint sensing area 102. The fingerprint sensing array may be disposed above the touch sensing array in an overlapping manner. A vertical structure of the touch screen 100 will be described below with reference to FIG. 2. However, according to an exemplary embodiment, the fingerprint sensing array may be disposed below the touch sensing array in a similar overlapping manner.

Referring to FIG. 2, the touch screen 100 may include a display panel 10, a touch sensing array 20, and a fingerprint sensing array 30. Also, the touch screen 100 may include first to fifth layers 110 to 150, sequentially stacked in a direction toward the front surface FS of the touch screen 100. The display panel 10, the touch sensing array 20 and the fingerprint sensing array 30 may be formed in the first layer 110, the second layer 120, and the fourth layer 140, respectively.

display panel 10A window glass may be provided above the fifth layer 150. The window glass may include a material such as acryl, tempered glass, or the like, and may protect the touch screen 100 from an external impact or a scratch caused by a repetitive touch.

The third layer 130 may include a glass substrate. The glass substrate may be interposed between the touch sensing array 20 and the fingerprint sensing array 30. In addition, another kind of layer (or element) may be disposed above or below the first layer 110, the second layer 120, the third layer 130, and the fourth layer 140. For example, a polarizer may be disposed above the first layer 110 or the second layer 120.

The display panel 10 may display an image, based on image signals supplied from the driving integrated circuit (200 of FIG. 1). The display panel 10 may be implemented with one of a liquid crystal display (LCD), a light-emitting diode (LED) display, an organic light-emitting diode (OLED) display, an active-matrix OLED (AMOLED) display, an electrochromic display (ECD), a digital mirror device (DMD), an actuated mirror device (AMD), a grating light value (GLV) display, a plasma display panel (PDP), an electroluminescent display (ELD), and a vacuum fluorescent display (VFD), and may be implemented with another kind of flat panel or flexible panel.

The touch sensing array 20 may sense a touch input applied to the touch sensing area 101 of the touch screen 100 to generate a sensing signal, for example, a touch sensing signal. The touch sensing array 20 may provide the touch sensing signal to the driving integrated circuit 200.

The touch sensing array 20 may be implemented with a capacitive sensor. The touch sensing array 20 may include a plurality of touch sensing units which are arranged in a matrix form on an x-y plane. The touch sensing units may each be implemented with a sensing electrode disposed in the touch sensing array 20. The sensing electrode may include a transparent conductive material such as indium tin oxide (ITO), indium zinc oxide (IZO) or indium zinc tin oxide (IZTO).

In an exemplary embodiment, the touch sensing array 20 may be implemented as one body with the display panel 10. For example, the touch sensing array 20 may be provided in the display panel 10, and each of the touch sensing units included in the touch sensing array 20 may be implemented with one of various electrodes of the display panel 10. For example, the display panel 10 may have various electrodes such as a common electrode, a gate line electrode, and a data line electrode, and the touch sensing array 20 may have at least one of these electrodes of the display panel 10 as touch sensing units. For example, the common electrode may be used as a sensing unit of the touch sensing array 20.

The fingerprint sensing array 30 may sense a fingerprint of a user. When a finger of a user contacts or approximates the fingerprint sensing area 102 of the touch screen 100, the fingerprint sensing array 30 may sense a touch input and provide a sensing signal (for example, a fingerprint sensing signal) to the driving integrated circuit 200.

The fingerprint sensing array 30 may be implemented with a capacitive sensor. The fingerprint sensing array 30 may include a plurality of fingerprint sensing units which are arranged in a matrix form on the x-y plane. The fingerprint sensing units may each be implemented with sensing electrodes disposed in the fingerprint sensing array 30. The sensing electrodes may each include a transparent conductive material such as ITO, IZO or IZTO.

As illustrated in FIG. 2, the fingerprint sensing array 30 may be disposed above the touch sensing array 20, and may overlap one area of the touch sensing array 20 when viewed from or to the front surface FS of the touch screen 100. Therefore, as illustrated in FIG. 1, a portion of the touch sensing area 101 may overlap the fingerprint sensing area 102.

In an exemplary embodiment, an intermediate material may be filled into an area of the fourth layer 140 other than an area where the fingerprint sensing array 30 is provided. However, the present embodiment is not limited thereto. In other exemplary embodiments, sensor electrodes may be provided in a whole portion of the fourth layer 140, and only fingerprint sensing units provided in the fingerprint sensing area 102 may operate or enabled as the fingerprint sensing array 30.

When the touch screen device 1000 operates in a touch sensing mode, the fingerprint sensing array 30 according to an exemplary embodiment may sense a touch input. In other words, in the touch sensing mode, the fingerprint sensing array 30 may operate as a touch sensing array. In the touch sensing mode, the fingerprint sensing array 30 may provide touch sensing signals corresponding to the fingerprint sensing area 102 to the driving integrated circuit 200.

Referring to FIG. 1 again, the driving integrated circuit 200 may drive the touch screen 100. The driving integrated circuit 200 may provide image signals to the display panel 10 in order for an image to be displayed on the display panel 10 of the touch screen 100. The driving integrated circuit 200 may receive sensing signals (for example, touch sensing signals) from the touch sensing array 20 and/or the fingerprint sensing array 30 to determine whether a touch input occurs and calculate a position (i.e., touch coordinates) on the touch screen 100 at which the touch input occurs. The driving integrated circuit 200 may receive sensing signals (i.e., fingerprint sensing signals) from the fingerprint sensing array 30 to generate a fingerprint image or fingerprint data used to generate the fingerprint image. The driving integrated circuit 200 may include a plurality of integrated circuits (ICs) which respectively perform a display function, a touch sensing function, and a fingerprint sensing function.

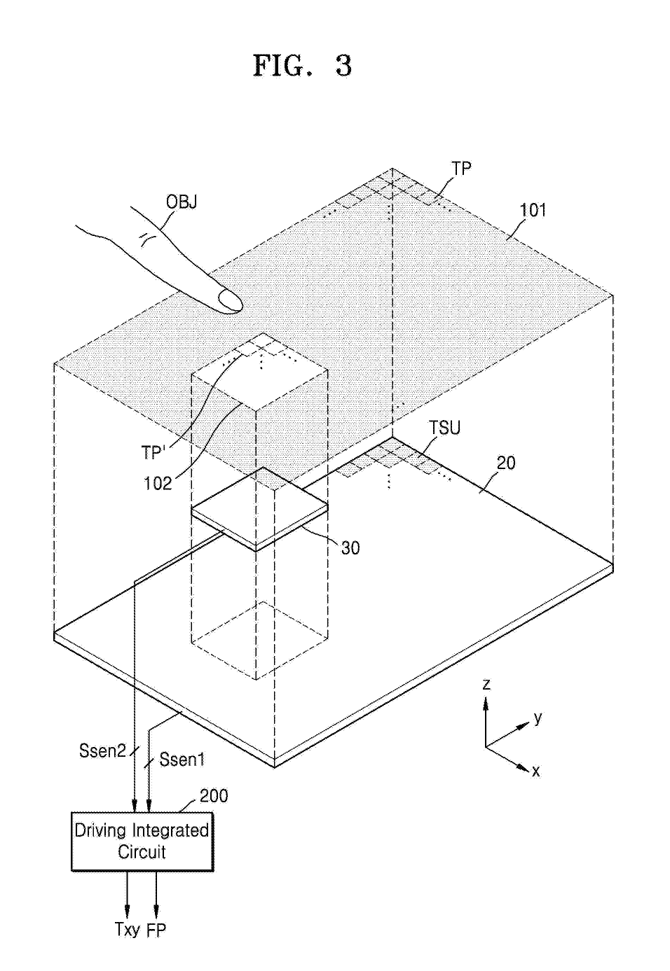

When the touch screen device 1000 operates in the touch sensing mode, the driving integrated circuit 200 according to an exemplary embodiment may calculate touch coordinates, based on the sensing signals provided from the touch sensing array 20 and/or the sensing signals provided from the fingerprint sensing array 30. This will be described below with reference to FIG. 3.

FIG. 3 is a diagram for describing a touch sensing mode operation of a touch screen device according to an exemplary embodiment. The touch sensing mode operation of FIG. 3 may be applied to the touch screen device 1000 of FIG. 1. Therefore, the description of the touch screen device 1000 made with reference to FIG. 1 may be applied to the present embodiment.

Referring to FIG. 3, a touch sensing array 20 may include a plurality of touch sensing units TSU, and the plurality of touch sensing units TSU may respectively correspond to a plurality of touch sensing points TP of a touch sensing area 101. A touch value of each of the plurality of touch points TP may be determined based on sensing signals (for example, first sensing signals) representing respective capacitances of the plurality of touch sensing units TSU.

When a touch input occurs in the touch sensing area 101, capacitances of touch sensing units TSU corresponding to a position (a position on an x-y plane) at which the touch input occurs may vary based on a mutual capacitance between the touch sensing array 20 and an object OBJ. Therefore, touch values of touch sensing points TP corresponding to a position at which a touch input occurs may vary. A driving integrated circuit 200 may calculate touch coordinates Txy, based on variations of the touch values of the touch sensing points TP.

As described above with reference to FIG. 2, a fingerprint sensing array 30 may be disposed above the touch sensing array 20, and may overlap a portion of the touch sensing array 20 in the fingerprint sensing area 102. The fingerprint sensing array 30 may also be implemented with a capacitive sensor. Therefore, the driving integrated circuit 200 may generate touch values of touch sensing points TP′ located in the fingerprint sensing area 102 among the touch sensing points TP, based on sensing signals (for example, second sensing signals Ssen2) provided from the fingerprint sensing array 30.

When the touch screen device 1000 performs a touch sensing mode operation, the driving integrated circuit 200 may generate first touch data, based on first sensing signals Ssen1 provided from the touch sensing array 20, and may generate second touch data, based on second sensing signals Ssen2 provided from the fingerprint sensing array 30. The driving integrated circuit 200 may calculate the touch coordinates Txy, based on the first touch data and the second touch data.

The first touch data may include touch values respectively corresponding to the touch sensing points TP of the touch sensing area 101. In an exemplary embodiment, the first touch data may include touch values respectively corresponding to the touch sensing points TP of a whole portion (including the fingerprint sensing area 102) of the touch sensing area 101. In other exemplary embodiments, the first touch data may include touch values respectively corresponding to the touch sensing points TP of a portion of the touch sensing area 101 other than the fingerprint sensing area 102.

The second touch data may include touch values respectively corresponding to the touch sensing points TP′ of the fingerprint sensing area 102. In an exemplary embodiment, a sensing resolution of the fingerprint sensing array 30 may be higher than that of the touch sensing array 20. The second touch data may include raw data (or an image) generated by converting the second sensing signals Ssen2, output from the fingerprint sensing array 30, into a digital value. The driving integrated circuit 200 may convert the raw data into the touch values respectively corresponding to the touch sensing points TP′ of the fingerprint sensing area 102.

In this manner, in a touch sensing operation, the driving integrated circuit 200 according to an exemplary embodiment may generate touch values by using the fingerprint sensing array 30, and may calculate the touch coordinates Txy based on the touch values, with respect to the fingerprint sensing area 102.

When the touch screen device 1000 operates in a fingerprint sensing mode, the driving integrated circuit 200 may generate a fingerprint image FP or fingerprint data used to generate the fingerprint image FP based on the second sensing signals Ssen2 provided from the fingerprint sensing array 30.

As described above, since the fingerprint sensing array 30 is disposed above the touch sensing array 20, a mutual capacitance between the touch sensing array 20 and an object OBJ in the fingerprint sensing area 102 may become lower than those of other portions of the touch sensing area 101. Therefore, a touch sensing sensitivity is reduced in the fingerprint sensing area 102. Also, a discontinuity of touch values occurs at touch sensing points TP located in a boundary area between the fingerprint sensing area 102 and the touch sensing area 101.

However, when operating in the touch sensing mode, the touch screen device 1000 according to an embodiment may generate touch data (for example, the second touch data) from the second sensing signal Ssen2 provided from the fingerprint sensing array 30, with respect to the fingerprint sensing area 102, and by using the second touch data when calculating the touch coordinates Txy, a touch sensing sensitivity is enhanced and an accuracy of the touch coordinates Txy increases.

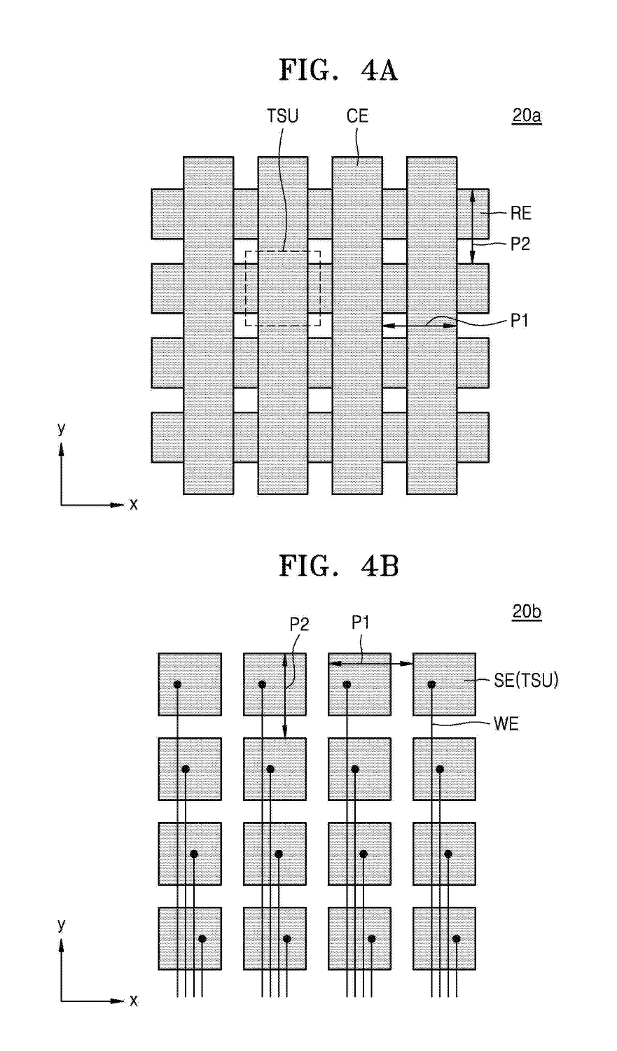

FIGS. 4A and 4B illustrate implementation examples of a touch sensing array.

Referring to FIG. 4A, a touch sensing array 20a may include a plurality of electrodes (for example, a plurality of column electrodes CE and a plurality of row electrodes RE) arranged in a column direction and a row direction. The number of the column electrodes CE and the row electrodes RE may be determined based on a width and a sensing resolution (a resolution per unit area) of the touch sensing array 20a. The column electrodes CE may be arranged in parallel at a first pitch P1. The row electrodes RE may be arranged in parallel at a second pitch P2. The first pitch P1 may be the same as or different from the second pitch P2. A shape of each of the column electrodes CE and the row electrodes RE may be variously modified.

The column electrodes CE and the row electrodes RE may intersect one another, and a touch sensing unit TSU may be provided at each intersection point. Therefore, a plurality of touch sensing units TSU may be arranged in a matrix form on an x-y plane.

In an exemplary embodiment, the touch sensing array 20a may be driven in a mutual capacitance type. Mutual capacitances between the column electrodes CE and the row electrodes RE may each be output as a sensing signal. For example, the column electrodes CE may be driving electrodes, and the row electrodes RE may be sensing electrodes. A driving signal may be sequentially applied to the column electrodes CE, and sensing signals may be output from the row electrodes RE. The sensing signals may represent the mutual capacitances between the column electrodes CE and the row electrodes RE, and in other words, the sensing signal may represent a capacitance of the touch sensing unit TSU. Therefore, touch values of touch sensing points (TP of FIG. 2) may be determined based on the sensing signals output from the touch sensing array 20a.

In an exemplary embodiment, the touch sensing array 20a may be driven in a self-capacitance type. A mutual capacitance between an object and each of the column electrodes CE and the row electrodes RE may be output as a sensing signal. The driving signal may be applied to each of the column electrodes CE and the row electrodes RE, and sensing signals may be output from the column electrodes CE and the row electrodes RE. The sensing signals may represent the mutual capacitances between the object and each of the column electrodes CE and the row electrodes RE. The touch values of the touch sensing points TP may be determined based on the sensing signals output from the column electrodes CE and the row electrodes RE.

In an exemplary embodiment, the touch sensing array 20a may be driven in the mutual capacitance type and the self-capacitance type, and the touch values of the touch sensing points TP may be determined based on sensing signals which are output according to the mutual capacitance type and the self-capacitance type.

Referring to FIG. 4B, a touch sensing array 20b may include a plurality of sensing electrodes SE arranged in a matrix form. The number of the sensing electrodes SE may be determined based on a width and a sensing resolution of the touch sensing array 20b. A shape of the sensing electrodes SE may be variously modified. The sensing electrodes SE may be arranged in a column direction at a first pitch P1 and arranged in a row direction at a second pitch P2. The first pitch P1 may be the same as or different from the second pitch P2.

Each of the sensing electrodes SE, a touch sensing unit TSU, may correspond to a touch sensing point (TP of FIG. 3). The sensing electrodes SE may be connected to different wiring electrodes WE, respectively. Driving signals may be applied to each of the sensing electrodes SE through the wiring electrodes WE, and sensing signals may be output through the wiring electrodes WE. Driving signals may be sequentially applied to the sensing electrodes SE in units of rows, and sensing signals may be output from the sensing electrodes SE to which the driving signals are applied.

Accordingly, the touch sensing array 20b may be driven in a self-capacitance type. A mutual capacitance between each of the sensing electrodes SE and an object may be output as a sensing signal.

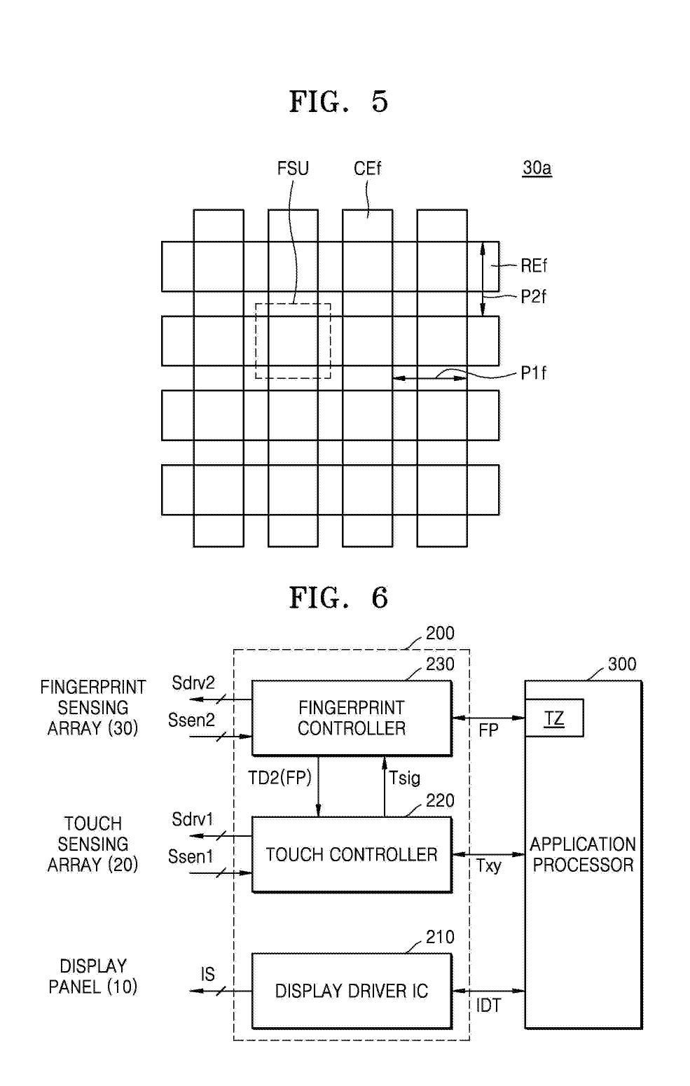

FIG. 5 illustrates an implementation example of a fingerprint sensing array.

Referring to FIG. 5, a fingerprint sensing array 30a may include a plurality of electrodes (for example, a plurality of column electrodes CEf and a plurality of row electrodes REf) arranged in a column direction and a row direction. The number of the column electrodes CEf and the row electrodes REf may be determined based on a width, a sensing resolution, etc. of the fingerprint sensing array 30a. The column electrodes CEf may be arranged in parallel at a first pitch P1f. The row electrodes REf may be arranged in parallel at a second pitch P2f The first pitch P1f may be the same as or different from the second pitch P2f. A shape of each of the column electrodes CEf and the row electrodes REf may be variously modified.

The column electrodes CEf and the row electrodes REf may intersect one another, and a fingerprint sensing unit FSU may be provided at each intersection point. Therefore, a plurality of fingerprint sensing units FSU may be arranged on an x-y plane.

Referring to FIGS. 5 and 4A, a structure of the fingerprint sensing array 30a may be similar to that of the touch sensing array 20a of FIG. 4A. Also, a structure of the fingerprint sensing array 30a may be provided similar to that of the touch sensing array 20b of FIG. 4B. However, the first pitch P1f and the second pitch P2f of the fingerprint sensing array 30a may be less than the first pitch P1 and the second pitch P2 of the touch sensing array 20a. In other words, a sensing resolution of the fingerprint sensing array 30a may be higher than that of the touch sensing array 20a.

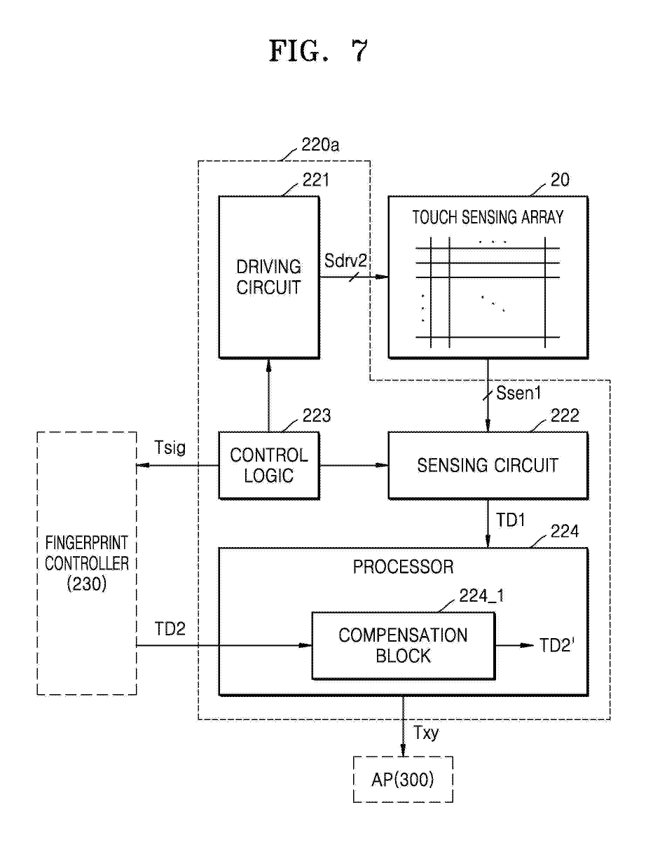

FIG. 6 is a block diagram illustrating a driving integrated circuit according to an exemplary embodiment. For convenience of description, an AP (Application Processor) 300 is illustrated together.

Referring to FIG. 6, the driving integrated circuit 200 may include a display driving circuit 210, a touch controller 220, and a fingerprint controller 230. The display driving circuit 210, the touch controller 220, and the fingerprint controller 230 may communicate with an external processor, for example, the AP 300.

The driving integrated circuit 200 may operate in a display mode, a touch sensing mode, and a fingerprint sensing mode. When the driving integrated circuit 200 operates in the display mode, the touch controller 220 may drive a display panel 10. When the driving integrated circuit 200 operates in the touch sensing mode, the touch controller 220 may drive a touch sensing array (20 of FIG. 2), and the fingerprint controller 230 may drive a fingerprint sensing array (30 of FIG. 2). When the driving integrated circuit 200 operates in the fingerprint sensing mode, the fingerprint controller 230 may drive the fingerprint sensing array (30 of FIG. 2). The display mode, the touch sensing mode, and the fingerprint sensing mode may be determined based on the AP 300.

The display driving circuit 210 may convert image data IDT, provided from the AP 300, into image signals IS and may provide the image signals IS to the display panel 10, thereby driving the display panel 10 to display an image.

The touch controller 220 may drive the touch sensing array 20 and may calculate touch coordinates Txy. The touch controller 220 may determine whether a touch input occurs or not. The touch controller 220 may provide the touch coordinates Txy to the AP 300. In this case, the touch controller 220 may generate the touch coordinates Txy, based on first touch data generated by the touch controller 220 and second touch data TD2 provided from the fingerprint controller 230.

The touch controller 220 may provide first driving signals Sdrv1 to the touch sensing array 20 to drive the touch sensing array 20 and may receive first sensing signals Ssen1 generated based on the first driving signals Sdrv1. The touch controller 220 may generate the first touch data, based on the first sensing signals Ssen1. The touch controller 220 may receive the second touch data TD2 from the fingerprint controller 230.

The first touch data may include touch values respectively corresponding to touch sensing points TP of a touch sensing area (101 of FIG. 3). The second touch data TD2 may include touch sensing values for a fingerprint sensing area (102 of FIG. 3) of the touch screen 100. The second touch data TD2 may include data values representing respective capacitances of fingerprint sensing units (FSU of FIG. 5). In an exemplary embodiment, the second touch data TD2 may include a fingerprint image FP or fingerprint data used to generate the fingerprint image FP.

The touch controller 220 may perform signal processing on the touch sensing values included in the second touch data TD2 to generate compensated second touch data. The compensated second touch data may include touch values corresponding to touch sensing points TP′ of the fingerprint sensing area 102. The touch controller 220 may compensate the touch sensing values included in the second touch data TD2 so as to match those touch sensing values with touch values (i.e., touch values included in the first touch data) generated by the touch sensing array 20 and the touch controller 220.

For example, the touch controller 220 may apply at least one of a gain and an offset to the data values included in the second touch data TD2. The gain and the offset may be predetermined. The gain and offset may be set based on a driving and sensing condition (for example, a level of each of the first driving signals Sdrv1 and a gain and offset of a sensing circuit included in the touch controller 220) of the touch controller 220 and a driving and sensing condition (for example, a level of each of second driving signals Sdrv2 and a gain and offset of a sensing circuit included in the fingerprint controller 230) of the fingerprint controller 230. The data values included in the second touch data TD2 may be converted into touch values corresponding to touch sensing points of the fingerprint sensing area 102.

The touch controller 220 may analyze at least one of the first touch data and the compensated second touch data to calculate the touch coordinates Txy.

In this manner, the touch controller 220 according to an exemplary embodiment may generate the touch coordinates Txy from at least one of the first touch data generated by the touch controller 220 and the second touch data provided from the fingerprint controller 230.

The fingerprint controller 230 may drive the fingerprint sensing array 30, and may generate the fingerprint image FP (or fingerprint data used to generate the fingerprint image FP) or the second touch data TD2. The fingerprint controller 230 may provide the second driving signals Sdrv2 to the fingerprint sensing array 30 to drive the fingerprint sensing array 30, and may receive second sensing signals Ssen2 generated based on the second driving signals Sdrv2. The fingerprint controller 230 may generate sensing data, based on the second sensing signals Ssen2. The touch controller 220 may receive the second touch data TD2 from the fingerprint controller 230. The sensing data may include data voltages generated by digitally converting the second sensing signals Ssen2.

When the driving integrated circuit 200 operates in the fingerprint sensing mode, the sensing data may include a fingerprint sensing value. The fingerprint controller 230 may generate the fingerprint image FP based on the sensing data and may provide the fingerprint image FP or the fingerprint data used to generate the fingerprint image FP to the AP 300. In an exemplary embodiment, the fingerprint controller 230 may provide the fingerprint image FP or the fingerprint data used to generate the fingerprint image FP to a trusted zone TZ of the AP 300. The AP 300 may include a rich execution environment (REE) and a trusted execution environment (TEE), and a trusted environment may be applied to the trusted zone TZ. The trusted zone TZ and other zones (for example, general zones) may be implemented as a physically separated type, a software separated type, or a combination type of physical separation and software separation.

When the driving integrated circuit 200 operates in the touch sensing mode, the sensing data may include a touch sensing value. The fingerprint controller 230 may provide the sensing data as the second touch data TD2 to the touch controller 220. In other exemplary embodiments, the fingerprint controller 230 may calculate the touch coordinates Txy, based on the sensing data. For example, when a touch input occurs in only the fingerprint sensing area 102, and the touch controller 220 and the fingerprint controller 230 recognize that the touch input occurs in the fingerprint sensing area 102, the fingerprint controller 230 may calculate the touch coordinates Txy, based on the sensing data.

In an exemplary embodiment, the touch controller 220 may provide a timing signal Tsig to the fingerprint controller 230, and the fingerprint controller 230 may drive the fingerprint sensing array 30 according to a driving timing determined based on the timing signal Tsig. The timing signal Tsig may include a vertical synchronization signal and/or a horizontal synchronization signal for driving the touch sensing array 20. The fingerprint controller 230 may internally generate a synchronization signal, based on the timing signal Tsig provided from the touch controller 220 and may drive the fingerprint sensing array 30, based on the synchronization signal.

The display driving circuit 210, the touch controller 220, and the fingerprint controller 230 may be implemented as different semiconductor chips. The display driving circuit 210, the touch controller 220, and the fingerprint controller 230 may communicate with the AP 300 according to a predetermined interface through different communication channels. For example, the interface may include one of an RGB interface, a central processing unit (CPU) interface, a serial interface, a mobile display digital interface (MDDI), an inter integrated circuit (I2C) interface, a serial peripheral interface (SPI), a micro controller unit (MCU) interface, a mobile industry processor interface (MIPI), an embedded display port (eDP) interface, a D-subminiature (D-sub), an optical interface, and a high definition multimedia interface (HDMI). Additionally or alternatively, the interface may include, for example, a mobile high-definition link (MHL) interface, a secure digital (SD) card/multimedia card (MMC) interface, or an infrared data association (IrDA) standard interface. In addition, the interface may include various serial or parallel interfaces.

However, the present embodiment is not limited thereto, and in other exemplary embodiments, at least two of the display driving circuit 210, the touch controller 220, and the fingerprint controller 230 may be integrated into one same semiconductor chip. For example, the display driving circuit 210 and the touch controller 220 may be implemented as one chip. In other exemplary embodiments, the touch controller 220 and the fingerprint controller 230 may be implemented as one chip, in which case some of elements of the touch controller 220 may also perform some of functions of the fingerprint controller 230. At least two elements implemented as one chip may communicate with the AP 300 through the same communication channel or different communication channels. According to an exemplary embodiment, the driving integrated circuit 200 may be implemented as a software module, and accordingly, the display driving circuit 210, the touch controller 220, and the fingerprint controller 230 may each be implemented as a sub-module of the driving integrated circuit 200.

FIG. 7 is a block diagram illustrating a touch controller according to an exemplary embodiment. A touch controller 220a of FIG. 7 may be applied as the touch controller 220 of FIG. 6. Therefore, the description of the touch controller 220 made with reference to FIG. 6 may be applied to the touch controller 220a of FIG. 7.

Referring to FIG. 7, the touch controller 220a may include a driving circuit 221, a sensing circuit 222, a control logic 223, and a processor 224.

The driving circuit 221 may provide first driving signals Sdrv1 to electrodes of a touch sensing array 20 to drive the touch sensing array 20. Touch sensing units (TSU of FIGS. 4A and 4B) of the touch sensing array 20 may be sequentially driven in units of columns or units of rows, and thus, first sensing signals Ssen1 may be output in units of columns or units of rows.

The sensing circuit 222 may receive the first sensing signals Ssen1 provided from the touch sensing array 20, and may convert the first sensing signals Ssen1 into digital values. The digital values may be output as first touch data TD1.

The control logic 223 may control all operations of the touch controller 220a, and particularly, may control an operation timing of each of the driving circuit 221 and the sensing circuit 222. Also, the control logic 223 may provide a timing signal Tsig to the fingerprint controller 230. The fingerprint controller 230 may drive a fingerprint sensing array (30 of FIG. 2), based on the timing signal Tsig, thereby generating second touch data TD2.

The processor 224 may receive the second touch data TD2 from the fingerprint controller 230 and may calculate touch coordinates Txy, based on at least one of the first touch data TD1 and the second touch data TD2.

The processor 224 may include a compensation block 224_1. The compensation block 224_1 may compensate data values (for example, touch sensing values) included in the second touch data TD2 so as to match the data values with touch values included in the first touch data TD1. In other words, the compensation block 224_1 may match the second touch data TD2 with the first touch data TD1. The second touch data TD2 may be converted into compensated second touch data through a compensation operation of the compensation block 224_1.

The processor 224 should first match the first touch data TD1 with the second touch data TD2, for calculating the touch coordinates Txy based on the first touch data TD1 and the second touch data TD2. Since a sensing environment (for example, a sensing resolution, a distance to an object, etc.) of a touch sensing array (20 of FIG. 2) differs from a sensing environment of a fingerprint sensing array (30 of FIG. 2) and settings of circuits (for example, a gain of an amplification circuit, a conversion resolution of an analog-to-digital converter, etc.) for converting a sensing signal into a touch sensing value differ, it is difficult to use touch sensing values included in the second touch data TD2 as touch values as-is.

The compensation block 224_1 may apply at least one of a compensation gain and a compensation offset which are set by reflecting a sensing environment and a circuit setting to the touch sensing values included in the second touch data TD2, thereby compensating the touch sensing values included in the second touch data TD2.

In an exemplary embodiment, the touch sensing values included in the second touch data TD2 may be received in a reference number unit. A representative value of the touch sensing values among the touch sensing values included in the second touch data TD2 may correspond to a touch value corresponding to one touch sensing point TP′ (FIG. 3) or a fingerprint sensing unit FSU (FIG. 5) of the fingerprint sensing area 102. The reference number unit may be set based on a touch pitch (for example, the first pitch P1 and the second pitch P2 of FIGS. 4A and 4B) and a fingerprint pitch (for example, the first pitch P1f and the second pitch P2f of FIG. 5). The processor 224 may further include an operation circuit for calculating (for example, summing, highest value selection, or intermediate value selection, etc.) representative values by calculating touch sensing values received in the reference number unit in the second touch data TD2. In other exemplary embodiments, the representative values of the touch sensing values received in the reference number unit may be received as the second touch data TD2. The compensation block 224_1 may apply at least one of a compensation gain and a compensation offset to the representative values.

Therefore, the second touch data TD2 may be converted into compensated second touch data TD2′. The compensated second touch data TD2′ may include touch values corresponding to touch sensing points of a fingerprint sensing area (102 of FIG. 3).

The processor 224 may calculate the touch coordinates Txy, based on the first touch data TD1 and the compensated second touch data TD2′. The processor 224 may analyze the touch values, which correspond to the touch sensing area 101 and are included in the first touch data TD1, and the touch values which correspond to the fingerprint sensing area 102 and are included in the compensated second touch data TD2′, thereby calculating the touch coordinates Txy.

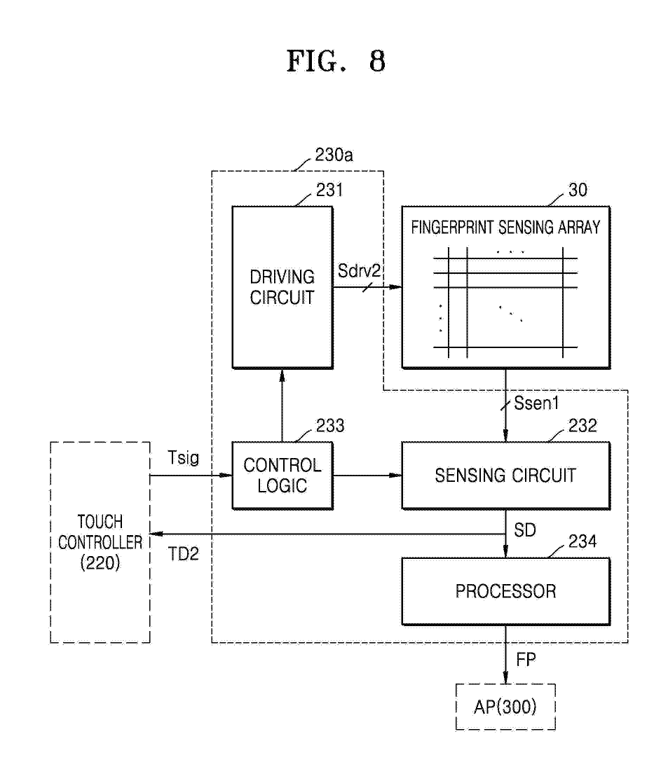

FIG. 8 is a block diagram illustrating a fingerprint controller according to an exemplary embodiment. A fingerprint controller of FIG. 8 may be applied as the fingerprint controller 230 of FIG. 6. Therefore, the description of the fingerprint controller 230 made with reference to FIG. 6 may be applied to the fingerprint controller 230a of FIG. 8.

Referring to FIG. 8, the fingerprint controller 230a may include a driving circuit 231, a sensing circuit 232, a control logic 233, and a processor 234.

The driving circuit 231 may provide driving second signals Sdrv2 to electrodes of a fingerprint sensing array 30 to drive the fingerprint sensing array 30. Fingerprint sensing units (FSU of FIG. 5) of the fingerprint sensing array 30 may be sequentially driven in units of columns or units of rows, and thus, second sensing signals Ssen2 may be output in units of columns or units of rows.

The sensing circuit 232 may receive the second sensing signals Ssen2 provided from the fingerprint sensing array 30, and may convert the second sensing signals Ssen2 into digital values. The digital values may be output as sensing data SD. The sensing data SD may be raw data.

The control logic 233 may control all operations of the fingerprint controller 230a, and particularly, may control an operation timing of each of the driving circuit 231 and the sensing circuit 232. In an exemplary embodiment, the control logic 233 may determine an operation timing of the driving circuit 231 and an operation timing of the sensing circuit 232, based on a timing signal Tsig received from the touch controller 220. The control logic 233 may generate a synchronization signal, based on the timing signal Tsig, and may determine a driving timing of the fingerprint sensing array 30 based on the synchronization signal.

The processor 234 may generate a fingerprint image FP or fingerprint data used to generate the fingerprint image FP, based on the sensing data SD, and may provide the fingerprint image FP or the fingerprint data used to generate the fingerprint image FP to an AP 300.

In a touch sensing mode operation, each of the second sensing signals Ssen2 may be a touch sensing signal generated by sensing a touch input applied to the fingerprint sensing array 30, namely, a touch input applied to a fingerprint sensing area (102 of FIG. 2). Therefore, the sensing data SD may include touch sensing values. The sensing data SD may be provided as second touch data TD2 to the touch controller 220. In other exemplary embodiments, the fingerprint controller 230a may further include an operation circuit for calculating representative values by calculating touch sensing values included in the sensing data SD received in a reference number unit which is set based on a touch pitch and a fingerprint pitch, and the representative values may be provided to the touch controller 220 as the touch data TD2. In other exemplary embodiments, an image (for example, a fingerprint image FP) output from the processor 234 may be provided to the touch controller 220 as second data TD2.

In an exemplary embodiment, the processor 234 may calculate touch coordinates, based on the sensing data SD including touch sensing values, and may provide the touch coordinates to the AP 300.

In other exemplary embodiments, the fingerprint controller 230a and the touch controller 220a (FIG. 7) may be implemented as one chip, in which case the functions of at least the processor 224 of the touch controller 220a may also perform the functions of the processor 234 of the fingerprint controller 230.

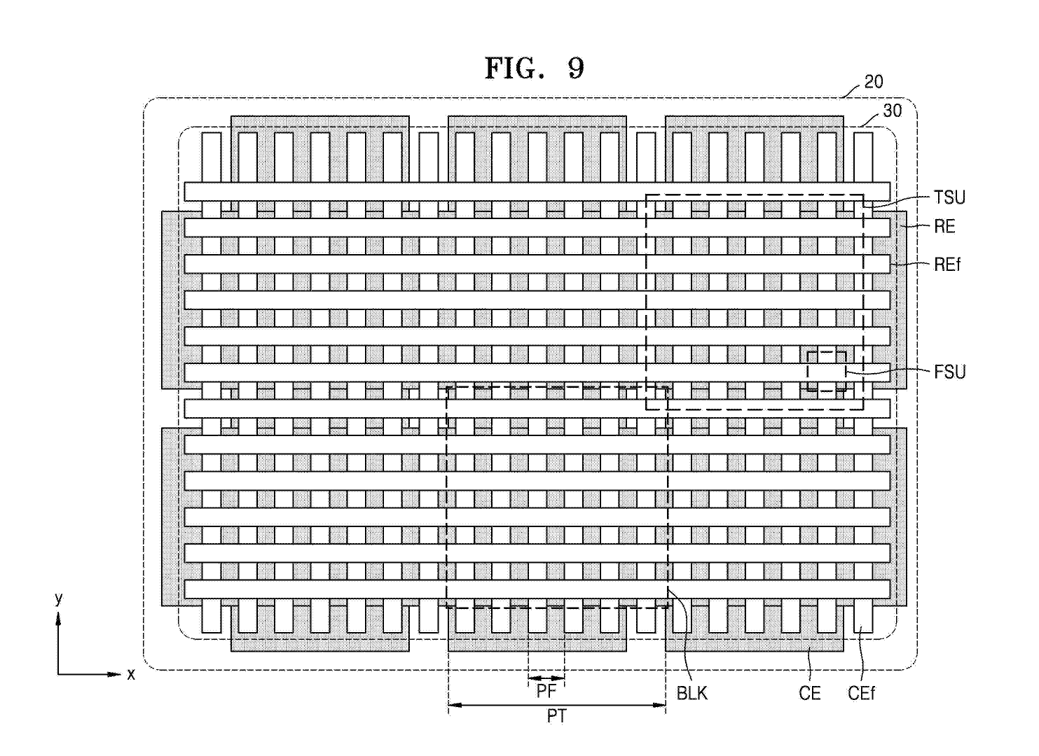

FIG. 9 is a diagram for describing a sensing resolution of a touch sensing array and a sensing resolution of a fingerprint sensing array, according to an exemplary embodiment.

Referring to FIG. 9, a width of each of electrodes CE and RE of the touch sensing array 20 may be greater than that of each of electrodes CEf and REf of the fingerprint sensing array 30. Also, an interval (i.e., a touch pitch PT) between the electrodes CE and RE of the touch sensing array 20 may be wider than an interval (i.e., a fingerprint pitch PF) between the electrodes CEf and REf of the fingerprint sensing array 30. Therefore, a sensing resolution (a resolution per unit area) of the fingerprint sensing array 30 may be higher than that of the touch sensing array 20. A size of a touch sensing unit TSU may be greater than that of a fingerprint sensing unit FSU. As described above with reference to FIG. 2, the touch sensing unit TSU may be provided in plurality, and the touch sensing units TSU may respectively correspond to touch sensing points. Accordingly, the fingerprint sensing unit FSU may be provided in plurality, and touch sensing values respectively corresponding to the plurality of fingerprint sensing units FSU may correspond to a touch value corresponding to one touch sensing point TP.

Therefore, a fingerprint controller (230 of FIG. 6) may provide touch sensing values to a touch controller (220 of FIG. 6) in a reference number unit which is set based on the touch pitch PT and the fingerprint pitch PF. For example, the fingerprint controller 230 may provide the touch sensing values to the touch controller 220 in a block unit BLK illustrated. The touch controller 220 may compensate a value obtained by performing an operation such as an arithmetic operation (for example, summation, averaging, or selecting a representative value among the touch sensing values) on the touch sensing values received in the block unit BLK, thereby generating an operational value corresponding to one touch sensing point TV included in a fingerprint sensing area (e.g., 102 of FIG. 3). Here, the reference number may be set between 50 and 60, preferably but not necessarily 57, according to a design of the touch screen 100 in which the touch pitch PT and the fingerprint pitch PF may be 4 mm and 70 μm, respectively. The touch controller 220 may apply at least one of a compensation gain and a compensation offset to each of a plurality of operational values. Therefore, touch values corresponding to the fingerprint sensing area 102 may be generated.

In an exemplary embodiment, the fingerprint controller 230 may perform an arithmetic operation on touch sensing values in the block unit BLK to generate a plurality of representative values. The fingerprint controller 230 may provide the plurality of representative values as second touch data TD2 to the touch controller 220. The touch controller 220 may compensate each of the plurality of representative values to generate touch values corresponding to the fingerprint sensing area 102.

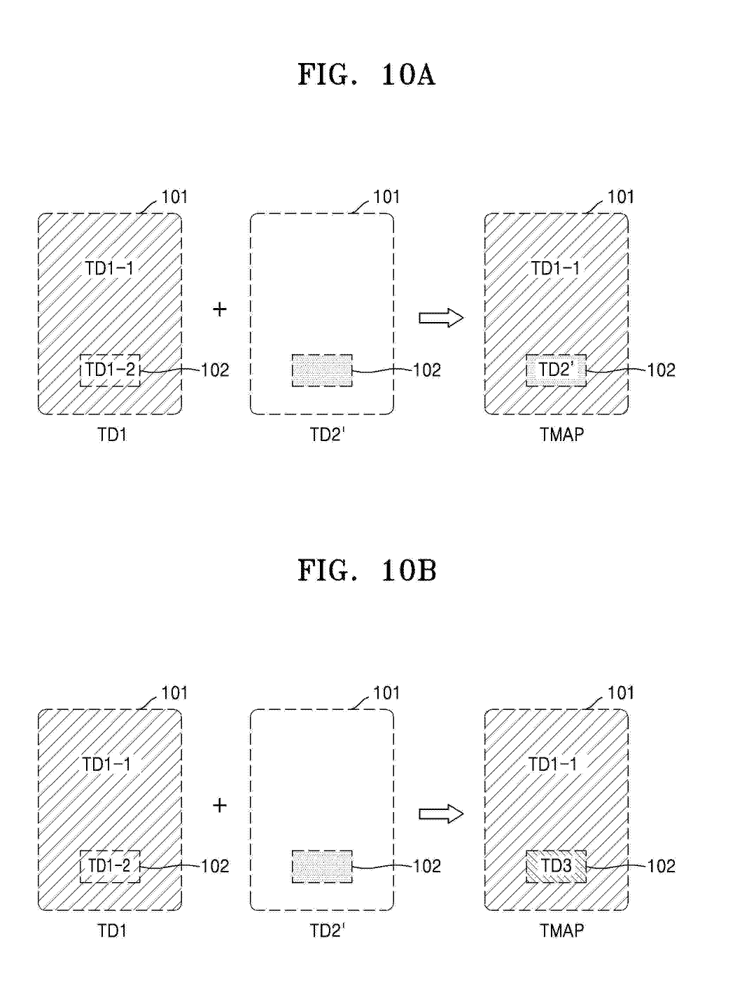

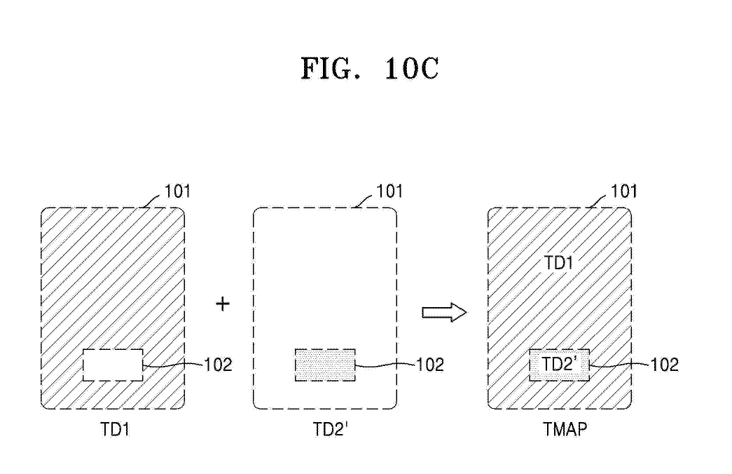

FIGS. 10A to 10C are diagrams illustrating a method of calculating, by using a touch controller, touch coordinates by using first touch data and compensated second touch data, according to exemplary embodiments.

Referring to FIG. 10A, first touch data TD1 may include touch values corresponding to a whole portion of a touch sensing area 101. The first touch data TD1 may include first data TD1-1, including touch values corresponding to areas of the touch sensing area 101 other than a fingerprint sensing area 102, and second data TD1-2 including touch values corresponding to the fingerprint sensing area 102. Compensated second touch data TD2′ may include touch values corresponding to the fingerprint sensing area 102. The touch controller 220 may calculate touch coordinates, based on the first data TD1-1 of the first touch data TD1 and the compensated second touch data TD2′. For example, the touch controller 220 may generate a touch map TMAP, based on the first data TD1-1 of the first touch data TD1 and the compensated second touch data TD2′, and may analyze the touch map TMAP to generate touch coordinates.

Referring to FIG. 10B, first touch data TD1 may include touch values corresponding to a whole portion of a touch sensing area 101. The first touch data TD1 may include first data TD1-1, including touch values corresponding to areas of the touch sensing area 101 other than a fingerprint sensing area 102, and second data TD1-2 including touch values corresponding to the fingerprint sensing area 102. Compensated second touch data TD2′ may include touch values corresponding to the fingerprint sensing area 102. The touch controller 220 may generate third touch data TD3, based on the second data TD1-2 and the compensated second touch data TD2′. The touch controller 220 may calculate touch coordinates, based on the first data TD1-1 of the first touch data TD1 and the third touch data TD3. For example, the touch controller 220 may generate a touch map TMAP, based on the first data TD1-1 and the third touch data TD3 and may analyze the touch map TMAP to generate touch coordinates.

In an exemplary embodiment, the touch controller 220 may generate the third touch data TD3, based on second touch data instead of the compensated second touch data TD2′. The touch controller 220 may compensate the second data TD1-2 of the first touch data TD1, based on the second touch data, thereby generating the third touch data TD3. The touch controller 220 may use touch values of the first touch data TD1 generated based on sensing signals provided from a touch sensing array (20 of FIG. 2), and in this case, may apply a compensation value calculated based on touch values corresponding to the fingerprint sensing area 102 (i.e., touch sensing values of the second touch data for the second data TD1-2), thereby increasing a touch sensing sensitivity of the fingerprint sensing area 102 and preventing a discontinuity of touch values in a boundary of the fingerprint sensing area 102).

Referring to FIG. 10C, first touch data TD1 may include touch values corresponding to regions of a touch sensing area 101 other than a fingerprint sensing area 102. Compensated second touch data TD2′ may include touch values corresponding to the fingerprint sensing area 102. A touch controller (220 of FIG. 6) may generate touch coordinates on a touch screen (100 of FIG. 2), based on the first touch data TD1 and the compensated second touch data TD2′. For example, the touch controller 220 may generate a touch map TMAP, based on the first touch data TD1 and the compensated second touch data TD2′, and may analyze the touch map TMAP to generate touch coordinates.

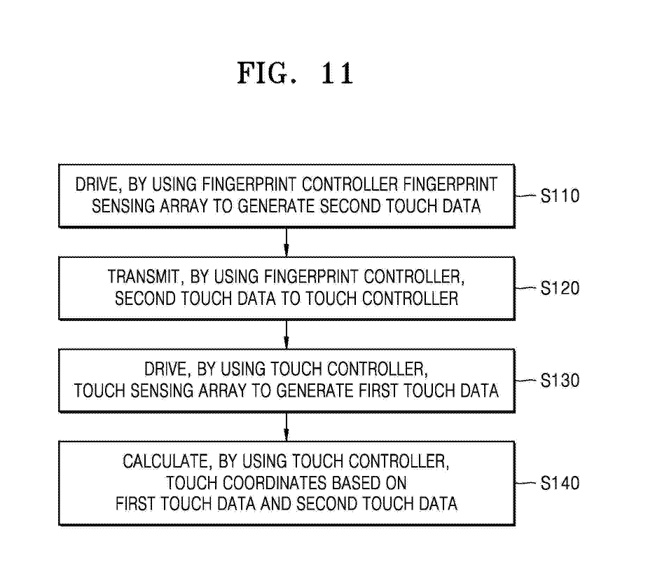

FIG. 11 is a flowchart illustrating a touch sensing method according to an exemplary embodiment. The touch sensing method of FIG. 11 may be performed by the touch controller 220 and the fingerprint controller 230 of the driving integrated circuit 200 of FIG. 6. Therefore, the description made with reference to FIG. 6 may be applied to the present embodiment.

Referring to FIGS. 11 and 6, in operation S110, the fingerprint controller 230 may drive the fingerprint sensing array 30 to generate the second touch data TD2. The fingerprint controller 230 may generate the second touch data TD2, based on the second sensing signals Ssen2 received from the fingerprint sensing array 30. The second touch data TD2 may include touch sensing values corresponding to the fingerprint sensing area 102 of the touch screen 100. The touch sensing values may be raw data obtained by converting the second sensing signals Ssen2 into the digital values.

In operation S120, the fingerprint controller 230 may transmit the second touch data TD2 to the touch controller 220. In an embodiment, the fingerprint controller 230 may transmit the touch sensing values to the touch controller 220 in a reference number unit which is set based on a touch pitch and a fingerprint pitch. In other exemplary embodiments, the fingerprint controller 230 may perform an arithmetic operation on the touch sensing values in the reference number unit to generate representative values (or operational values) and may transmit the representative values as the second touch data TD2 to the touch controller 220.

In operation S130, the touch controller 220 may drive the touch sensing array 20 to generate the first touch data TD1. The touch controller 220 may generate the first touch data TD1, based on the first sensing signals Ssen1 received from the touch sensing array. The first touch data TD1 may include touch values corresponding to the touch sensing points of the touch sensing area 101 of the touch screen 100.

In operation S140, the touch controller 220 may calculate the touch coordinates Txy, based on the first touch data TD1 and the second touch data TD2. The touch controller 220 may compensate the touch sensing values of the second touch data TD2 so as to match the touch sensing values with touch values of the first touch data TD1, and may analyze the compensated touch sensing values (i.e., the compensated second touch data and the first touch data TD1) to calculate the touch coordinates Txy.

In an exemplary embodiment, operation S120 may be performed simultaneously with operation S130. In other words, the operation S120 may be performed while the operation S130 is performed. Also, in an exemplary embodiment, an operation of compensating for the second touch data TD2 in operation S140 may be performed simultaneously with operation S130.

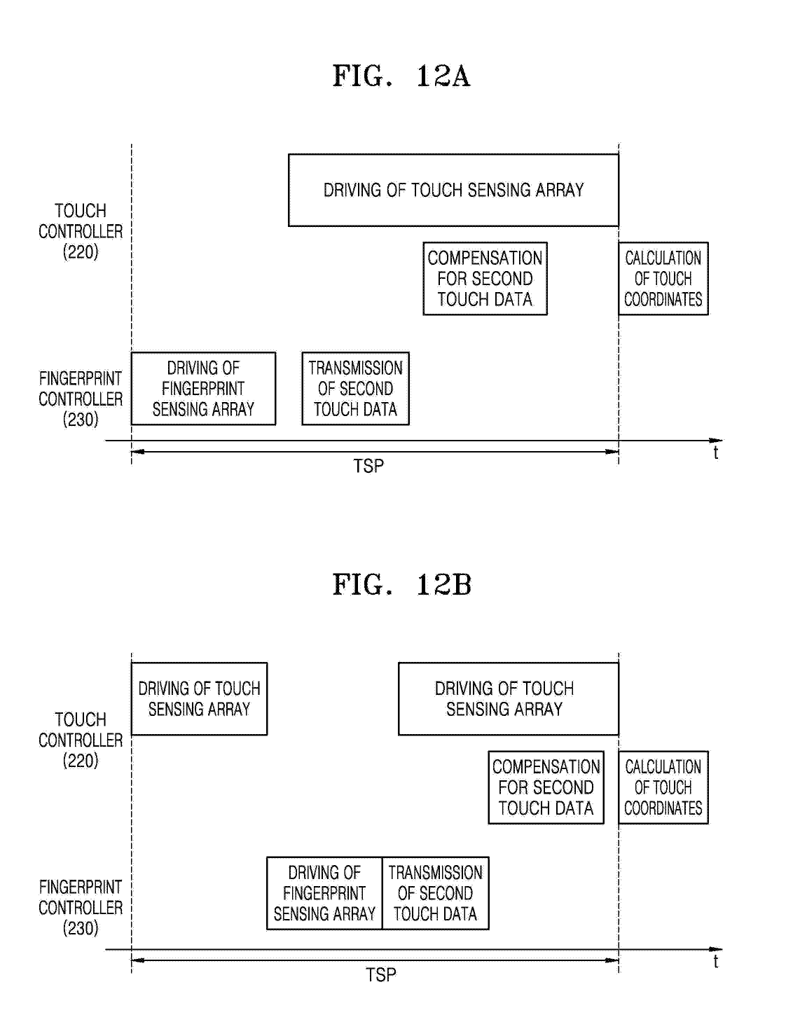

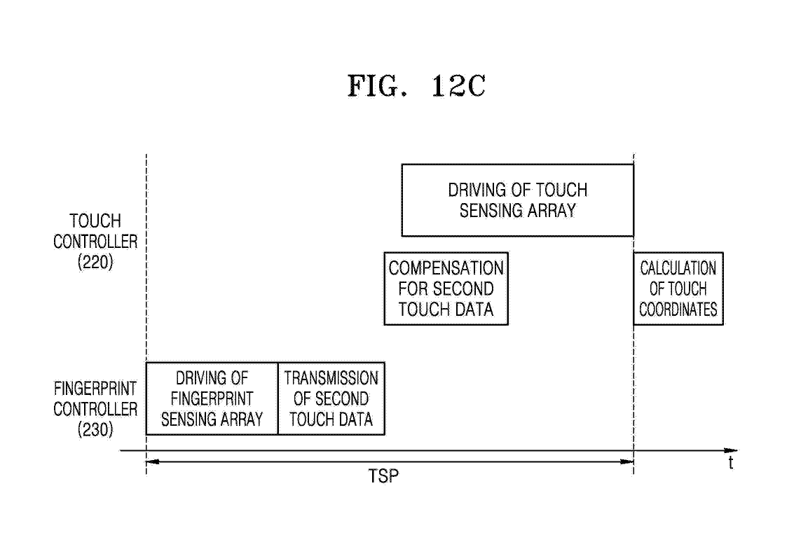

FIGS. 12A to 12C are timing diagrams of a fingerprint controller and a touch controller based on the touch sensing method of FIG. 11, according to exemplary embodiments.

FIGS. 12A to 12C, the touch sensing period TSP is a period in which the fingerprint controller 230 drives the fingerprint sensing array and the touch controller 220 drives the touch sensing array 20 to generate touch data. One touch sensing period may be the same a driving cycle of the touch screen 100.

Referring to FIG. 12A, when a touch sensing period TSP starts, the fingerprint controller 230 may drive the fingerprint sensing array 30. The fingerprint controller 230 may generate second touch data TD2. Subsequently, the touch controller 220 may drive the touch sensing array 20 to generate first touch data TD1. In order to prevent noise from occurring in a sensing signal, the touch controller 220 may drive the touch sensing array 20 after an operation of driving, by using the fingerprint controller 230, the fingerprint sensing array 30 is completed.

When the touch controller 220 drives the touch sensing array 20, the fingerprint controller 230 may transmit the second touch data TD2 to the touch controller 220. When the touch controller 220 drives the touch sensing array 20, the touch controller 220 may receive and compensate the second touch data TD2. The touch controller 220 may drive the touch sensing array 20, and simultaneously, may receive the second touch data TD2 from the fingerprint controller 230 and compensate the second touch data TD2. The touch controller 220 may complete the touch sensing driving within the touch sensing period TSP. When the driving of the touch sensing array 20 is completed, namely, when touch data (i.e., the first touch data TD1) including touch values corresponding to the touch sensing area 101 is generated, the touch controller 220 may calculate touch coordinates, based on the first touch data TD1 and the second touch data TD2.

Referring to FIG. 12B, when a touch sensing period TSP starts, the touch controller 220 may first drive the touch sensing array 20. The touch sensing array 20 may be provided in plurality, and the touch controller 220 may sequentially drive the touch sensing arrays 20 in units of columns or units of rows. For example, a plurality of touch sensing units arranged in a matrix form may be sequentially driven in the order of a most significant row to a least significant row.

At this time, when an order in which a row included in the fingerprint sensing area 102 is to be driven arrives, the fingerprint controller 230 may drive the fingerprint sensing array 30. The fingerprint controller 230 may generate second touch data TD2.

When the driving of the fingerprint sensing array 30 is completed, the touch controller 220 may again drive the touch sensing arrays 20. The touch controller 220 may again drive the touch sensing arrays 20 from a column or a row where driving is previously stopped. For example, the touch controller 220 may sequentially drive the touch sensing arrays 20 from a row, where driving is previously stopped, to the least significant row. At this time, the fingerprint controller 230 may transmit the second touch data TD2 to the touch controller 220. The touch controller 220 may drive the touch sensing arrays 20, and simultaneously, may receive the second touch data TD2. Also, the touch controller 220 may compensate for the second touch data TD2.

When the driving of the touch sensing arrays 20 is completed, the touch controller 220 may calculate touch coordinates, based on the first touch data TD1 and the compensated second touch data TD2.

Referring to FIG. 12C, when a touch sensing period TSP starts, the fingerprint controller 230 may drive the fingerprint sensing array 30. The fingerprint controller 230 may generate second touch data TD2, and transmit the second touch data TD2 to the touch controller 220. The touch controller 220 may receive the second touch data TD2 and compensate the second touch data TD2. The touch controller 220 may drive the touch sensing array 20 at the same time as or after the compensation of the second touch data to generate first touch data TD1.

In FIG. 12C, the touch controller 220 drives the touch sensing array 20 before the compensation of the second touch data is completed, but the present embodiment is not limited thereto. In an exemplary embodiment, the touch controller 220 may drive the touch sensing array 20 after the compensation of the second touch data is completed. When the driving of the touch sensing array 20 is completed, the touch controller 220 may calculate touch coordinates based on the first touch data TD1 and the compensated second touch data TD2.

As described above with reference to FIGS. 12A to 12C, at an initial stage or a middle stage of the touch sensing period TSP, the fingerprint controller 230 may drive the fingerprint sensing array 30 to generate the second touch data TD2, and then the touch controller 220 drives the touch sensing array 20 to generate the first touch data TD1. When the touch controller 220 drives the touch sensing array 20, the fingerprint controller 230 transmit the second touch data TD2 to the touch controller 220 or the touch controller 220 compensates the second touch data TD2 simultaneously with the driving of the touch sensing array 20. Therefore, a second touch data transmission time and/or a second touch data compensation time may not be required independently in the touch sensing period TSP. Accordingly, touch latency is prevented from increasing.

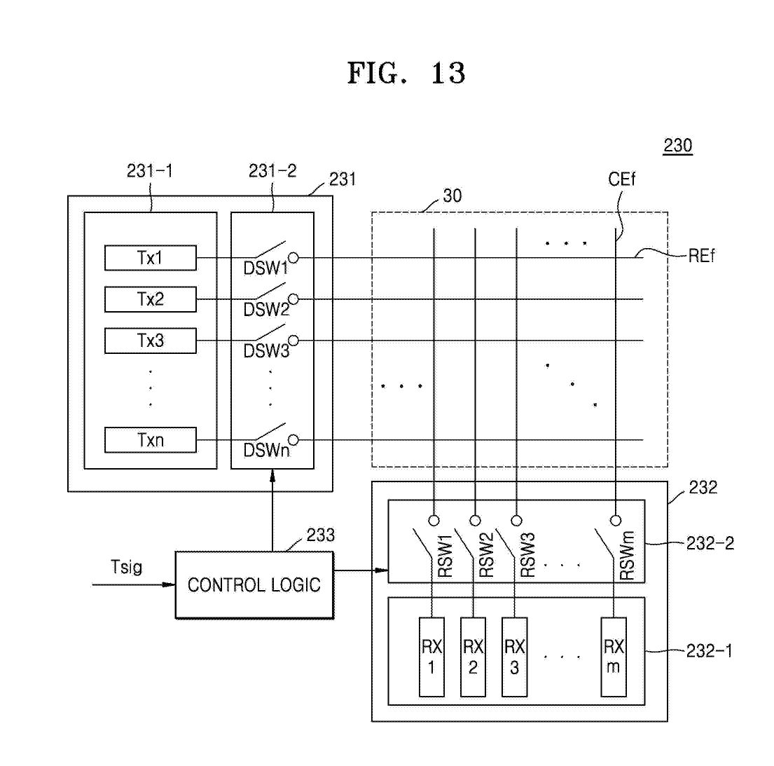

FIG. 13 is a diagram illustrating an operation of a fingerprint controller in a touch sensing method according to an exemplary embodiment. FIG. 13 illustrates an example of an operation of the fingerprint controller 230 when the touch controller 220 of FIG. 6 drives the touch sensing array 20. For convenience of description, the fingerprint sensing array 30 is illustrated together.

Referring to FIG. 13, a driving circuit 231 of the fingerprint controller 230 may include a transmission unit 231-1 including a plurality of transmitters Tx1 to Txn and a transmission switching unit 231-2 including a plurality of transmission switches DSW1 to DSWn respectively connected to the plurality of transmitters Tx. Each of the transmission switches DSW1 to DSWn may be connected to at least one driving electrode of the fingerprint sensing array 30, for example, a row electrode REf.

The A sensing circuit 232 of the fingerprint controller 230 may include a reception unit 232-1 including a plurality of receivers Rx1 to Rxm and a reception switching unit 232-2 including a plurality of reception switches RSW1 to RSWm respectively connected to the plurality of receivers Rx1 to Rxm. Each of the reception switches RSW1 to RSWm may be connected to at least one sensing electrode of the fingerprint sensing array 30, for example, a column electrode CEf.

A control logic 233 may control an operation of each of the driving circuit 231 and the sensing circuit 232. For example, in order to drive the fingerprint sensing array 30, the control logic 233 may control the transmission switches DSW1 to DSWn to be sequentially turned on. Therefore, a driving signal may be sequentially applied to driving electrodes of the fingerprint sensing array 30. When a sensing signal corresponding to the driving signal is received, the control logic 233 may control the reception switches RSW1 to RSWm to be simultaneously turned on. Accordingly, sensing signals may be received from sensing electrodes of the fingerprint sensing array 30.

When the touch controller 220 drives the touch sensing array 20, the control logic 233 may control the transmission switches DSW1 to DSWn and the reception switches RSW1 to RSWm to be turned off. Therefore, electrical connections between the plurality of transmitters Tx1 to Txn and the driving electrodes may be cut off, and electrical connections between the plurality of receivers Rx1 to Rxm and the sensing electrodes may be cut off. The driving electrodes and the sensing electrodes of the fingerprint sensing array 30 may be floated. In other words, no signal may be applied to the sensing electrodes and the driving electrodes.

In an embodiment, When the touch controller 220 drives the touch sensing array 20, if the driving electrodes and the sensing electrodes of the fingerprint sensing array 30 maintain a certain voltage level, a mutual capacitance between the touch sensing array 20 and an object is reduced, causing a reduction in touch sensing performance. Accordingly, when the touch controller 220 drives the touch sensing array 20, the fingerprint controller 230 may float the driving electrodes and the sensing electrodes of the fingerprint sensing array 30, thereby increasing touch sensing performance.

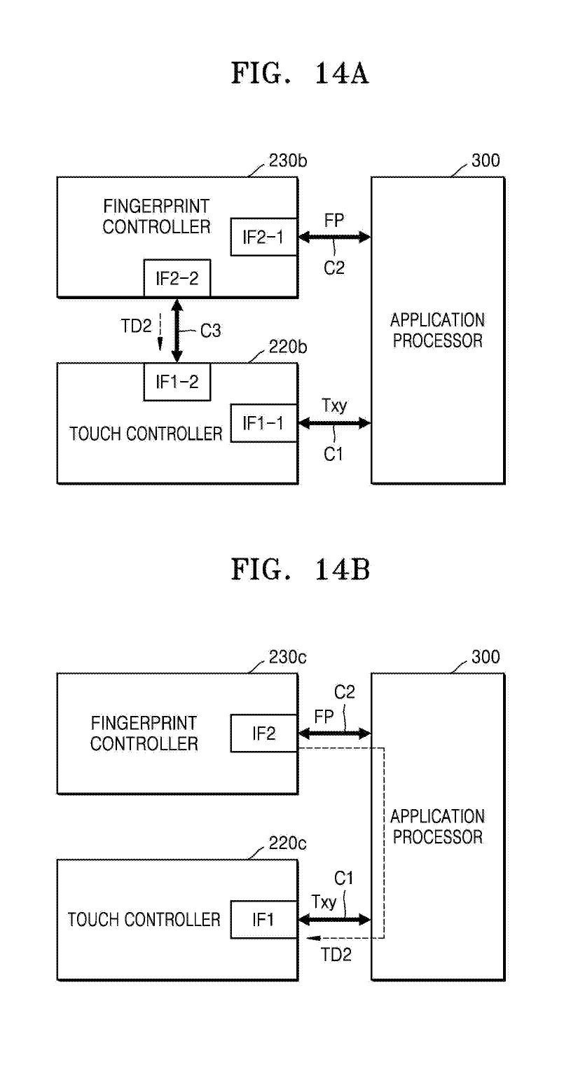

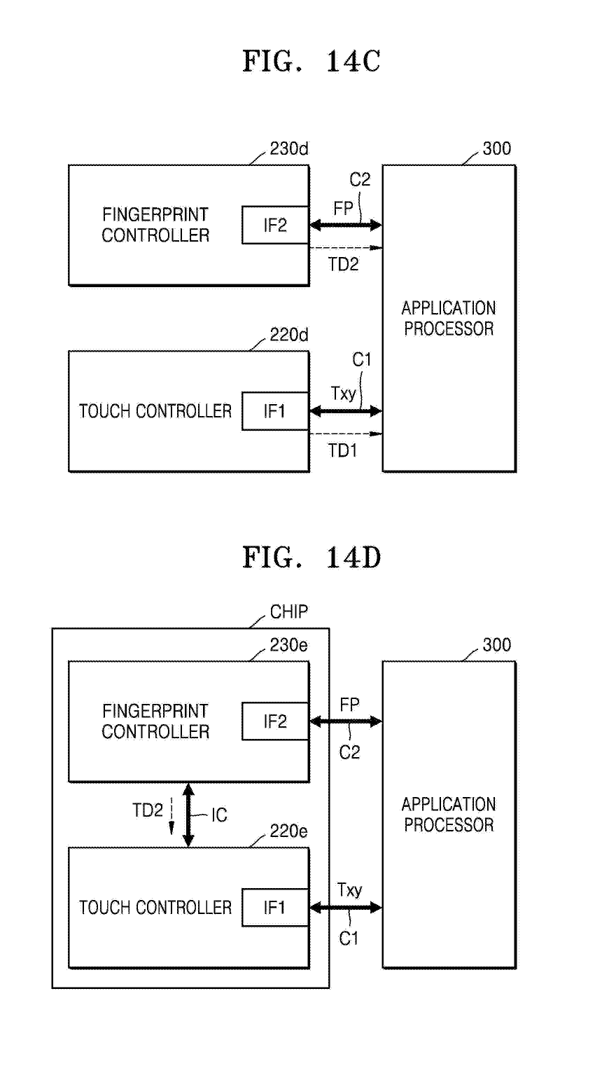

FIGS. 14A to 14D illustrate methods of transmitting, by using a fingerprint controller, second touch data to a touch controller. FIGS. 14A to 14C illustrate exemplary embodiments of an operation of each of the fingerprint controller 230 and the touch controller 220 of FIG. 6. Therefore, the descriptions of the fingerprint controller 230 and the touch controller 220 made with reference to FIG. 6 may be applied to the present embodiment.

Referring to FIG. 14A, a touch controller 220b may include a first interface circuit IF1-1 and a second interface circuit IF1-2. In addition, the touch controller 220b may further include other elements, for example, the elements illustrated in FIG. 7.

A fingerprint controller 230b may include a first interface circuit IF2-1 and a second interface circuit IF2-2. In addition, the fingerprint controller 230b may further include other elements, for example, the elements illustrated in FIG. 8.

In an exemplary embodiment, the touch controller 220b and the fingerprint controller 230b may be integrated into different semiconductor chips. However, the present embodiment is not limited thereto, and in other exemplary embodiments, the touch controller 220b and the fingerprint controller 230b may be integrated into one semiconductor chip.

The touch controller 220b may communicate with an AP 300 through the first interface circuit IF1-1. For example, the first interface circuit IF1-1 of the touch controller 220b may transmit touch coordinates Txy to the AP 300 through a first communication channel C1.

The fingerprint controller 230b may communicate with the AP 300 through the first interface circuit IF2-1. For example, the first interface circuit IF2-1 of the fingerprint controller 230b may transmit a fingerprint image FP or fingerprint data used to generate the fingerprint image FP to the AP 300 through a second communication channel C2.

The fingerprint controller 230b may directly communicate with the touch controller 220b through the second interface circuit IF2-2. The second interface circuit IF2-2 of the fingerprint controller 230b may directly transmit second touch data TD2 to the touch controller 220b through a third communication channel C3, and the touch controller 220b may receive the second touch data TD2 through the second interface circuit IF1-2. A serial or parallel interface may be applied to the third communication channel C3. For example, the interface may include an I2C interface, an SPI, or the like.

The touch controller 220b may calculate the touch coordinates Txy, based on the second touch data TD2 provided from the fingerprint controller 230b in addition to first touch data internally generated by the touch controller 220b, whereby a time taken in receiving the second touch data TD2 and a time taken in compensating the second touch data TD2 increases touch latency (a time taken from a time point, when a touch input occurs, to a time point when the touch coordinates are output). However, since the fingerprint controller 230b directly provides the second touch data TD2 to the touch controller 220, a time taken until the second touch data TD2 is generated and is received (i.e., the time at which the second touch data TD is transmitted) by the touch controller 220 is shortened.

Referring to FIG. 14B, a touch controller 220c and a fingerprint controller 230c may include interface circuits IF1 and IF2, respectively. The touch controller 220c and the fingerprint controller 230c may be integrated into different semiconductor chips or one semiconductor chip.

The touch controller 220c may communicate with an AP 300 through the interface circuit IF1. For example, the interface circuit IF1 of the touch controller 220c may transmit touch coordinates Txy to the AP 300 through a first communication channel C1.

The fingerprint controller 230c may communicate with the AP 300 through the interface circuit IF2. For example, the interface circuit IF2 of the fingerprint controller 230c may transmit a fingerprint image FP or fingerprint data used to generate the fingerprint image FP to the AP 300 through a second communication channel C2.

The fingerprint controller 230c may transmit second touch data TD2 to the AP 300 through the second communication channel C2, and then, the AP 300 may transmit the second touch data TD2 to the touch controller 220c through the first communication channel C1. Therefore, a separate communication channel for transmitting data (for example, the second touch data TD2) between the fingerprint controller 230 and the AP 300 is not needed. Accordingly, the touch controller 220c and the fingerprint controller 230c may transmit and receive the second touch data TD2 even without including a separate interface circuit for transmitting and receiving the second touch data TD2.

Referring to FIG. 14C, a touch controller 220d may transmit first touch data TD1 to an AP 300 through a first communication channel C1. A fingerprint controller 230d may transmit second touch data TD2 to the AP 300 through a second communication channel C2. When the AP 300 receives the first touch data TD1 and the second touch data TD2 the AP 300 may calculate touch coordinates Txy based on or first touch data TD1 and the second touch data TD2.

Referring to FIG. 14D, a touch controller 220e and a fingerprint controller 230e may be integrated into one semiconductor chip CHIP. The touch controller 220e and the fingerprint controller 230e may communicate with each other through an internal channel IC. The fingerprint controller 230e may directly transmit the second touch data TD2 to the touch controller 220e through the internal channel IC.

The touch controller 220e and the fingerprint controller 230e may include interface circuits IF1 and IF2, respectively, and may communicate with an AP 300 through the respective interface circuits IF1 and IF2. However, the present embodiment is not limited thereto. In other exemplary embodiments, the touch controller 220e and the fingerprint controller 230e may share one interface circuit and may communicate with the AP 300 through the one interface circuit.

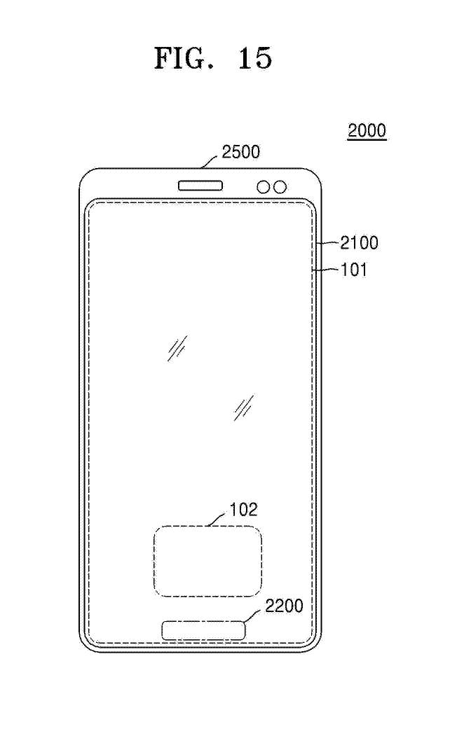

FIG. 15 is a diagram illustrating a smartphone 2000 according to an exemplary embodiment.

Referring to FIG. 15, the smartphone 2000 may include a touch screen panel 2100, a driving integrated circuit 2200, and a housing 2500. The smartphone 2000 may further include an AP that controls all operations of the smartphone 2000.

The housing 2500 may determine an appearance of the smartphone 2000 and protects internal elements (for example, integrated circuits (ICs), a battery, an antenna, etc.) of the smartphone 2000 from an external impact or a scratch. The driving integrated circuit 2200 may be disposed inside the housing 2500.

The touch screen panel 2100 may perform display, touch sensing, and fingerprint sensing to operate as an input/output (I/O) device of the touch screen device 1000. In an embodiment, the touch screen panel 2100 may sense a force of a touch input.

The touch screen 100 described above with reference to FIGS. 1 and 2 may be applied to the touch screen panel 2100. A touch sensing area 101 and a fingerprint sensing area 102 may be provided on a top of the touch screen panel 2100. A plurality of fingerprint sensing areas 102 may be provided on the top of the touch screen panel 2100. The fingerprint sensing area 102 may overlap a portion of the touch sensing area 101.

In a vertical structure of the touch screen panel 2100, a display panel and a touch sensing array may be disposed under the touch sensing area 101, and a fingerprint sensing array may be disposed under the fingerprint sensing area 102. The display, the touch sensing array, and the fingerprint sensing array may be sequentially stacked, and thus, the fingerprint sensing array may be disposed above the touch sensing array. In this manner, the fingerprint sensing array stacked above the display panel and/or the touch sensing array may be referred to as an on-display fingerprint sensor (or fingerprint sensing array).

A fingerprint authentication method, which uses a fingerprint of a user in order for the user to safely use the smartphone 2000, is being used as a security method. Therefore, the fingerprint sensing array may be included in the smartphone 2000. By using the on-display fingerprint sensing array, a separate space for the fingerprint sensing array is not required in a front surface of the smartphone 2000, and thus, an area of the touch screen panel 2100 is not reduced.

The driving integrated circuit 2200 may drive the touch screen panel 2100 to perform a display function, a touch sensing function, and a fingerprint sensing function. The driving integrated circuit 200 described above with reference to FIG. 1 or 6 may be applied to the driving integrated circuit 2200.

Since the fingerprint sensing array is stacked above the touch sensing array, touch sensing sensitivity is reduced, and a discontinuity of touch values in a boundary of the fingerprint sensing area 102 occurs. However, the driving integrated circuit 2200 according to an exemplary embodiment may calculate touch coordinates, based on sensing signals provided from the touch sensing array and the fingerprint sensing array of the touch screen panel 2100. The driving integrated circuit 2200 may generate touch values corresponding to the fingerprint sensing area 102, based on the sensing signals provided from the fingerprint sensing array. At this time, the fingerprint controller for driving the fingerprint sensing array may determine a time for driving the fingerprint sensing array in a touch sensing period, based on a timing signal provided from the touch controller which drives the touch sensing array. Driving of the fingerprint sensing array may be performed prior to driving of the touch sensing array, and when the touch controller drives the touch sensing array, the fingerprint controller may directly transmit touch data to the touch controller. The fingerprint controller and the touch controller may time-divisionally generate touch data without the AP, and the touch data may be shared, whereby touch latency does not increase.

As described above, in the smartphone 2000 according to an exemplary embodiment, although the fingerprint sensing array is provided on the front surface, an area of the touch screen panel 2100 is not reduced. Also, touch sensing performance is enhanced.

While the inventive concept has been particularly shown and described with reference to exemplary embodiments thereof, it will be understood that various changes in form and details may be made therein without departing from the spirit and scope of the following claims.

1. A touch controller for driving a touch screen comprising a touch sensing array and a fingerprint sensing array, the touch controller comprising:
a processor configured to:
generate first touch data from a first input, on a touch sensing area of the touch screen, which is sensed by the touch sensing array;
generate second touch data from a second input, on a fingerprint sensing area of the touch screen, which is sensed by at least one of the touch sensing array and the fingerprint sensing array; and
compensate the second touch data by adjusting touch values included therein to generate compensated second touch data,
wherein the first touch data, the second touch data and the compensated second touch data are used to calculate first input coordinates of the first input and second input coordinates of the second input on the touch screen, and
wherein the fingerprint sensing array is configured to receive a third input on the fingerprint sensing area to generate fingerprint data or a fingerprint image.

2. The touch controller of claim 1, wherein the second input is sensed by the fingerprint sensing array among the touch sensing array and the fingerprint sensing array.

3. Touch controller of claim 1, wherein the second input is sensed by both the touch sensing array and the fingerprint sensing array, and
wherein the second touch data generated from the second input which is sensed by the touch sensing array is not used to calculate the second input coordinates.

4. The touch controller of claim 1, wherein the compensated second touch data is generated by compensating the second touch data generated from the second input which is sensed by the fingerprint sensing array among the touch sensing array and the fingerprint sensing array.

5. The touch controller of claim 1, wherein the second input is sensed by both the touch sensing array and the fingerprint sensing array.

6. The touch controller of claim 5, wherein the compensated second touch data is generated by compensating the second touch data generated from the second input, which is sensed by the touch sensing array among the touch sensing array and the fingerprint sensing array, based on the second touch data generated from the second input which is sensed by the fingerprint sensing array among the touch sensing array and the fingerprint sensing array.

7. The touch controller of claim 1, wherein the processor compensates the second touch data, generated from the second input which is sensed by the fingerprint sensing array among the touch sensing array and the fingerprint sensing array, to generate the compensated second touch data based on a driving condition for driving the touch sensing array and a sensing condition of the touch sensing array and/or based on a driving condition for driving the fingerprint sensing array and a sensing condition of the fingerprint sensing array.

8-13. (canceled)

14. The touch controller of claim 1, further comprising a controller configured to drive the touch sensing array and the fingerprint sensing array,
wherein the second input is sensed by the fingerprint sensing array among the touch sensing array and the fingerprint sensing array, and
wherein, when a driving cycle of the touch screen begins, the controller drives the fingerprint sensing array to generate the second touch data prior to driving the touch sensing array to generate the first touch data, and controls the second touch data, generated from the second input which is sensed by the fingerprint sensing array, to be compensated while the touch sensing array is being driven.

15. The touch controller of claim 1, further comprising a controller configured to drive the touch sensing array and the fingerprint sensing array,
wherein the second input is sensed by the fingerprint sensing array among the touch sensing array and the fingerprint sensing array, and
wherein, when a driving cycle of the touch screen begins, the controller drives the fingerprint sensing array prior to the touch sensing array, and drives the touch sensing array after the driving the fingerprint sensing array is completed in the driving cycle of the touch screen.

16. The touch controller of claim 1, further comprising a controller configured to drive the touch sensing array and the fingerprint sensing array,
wherein the second input is sensed by the fingerprint sensing array among the touch sensing array and the fingerprint sensing array, and
wherein, when a driving cycle of the touch screen begins, the controller drives the touch sensing array prior to the fingerprint sensing array, and stops driving the touch sensing array and drives the fingerprint sensing array to sense the second input, and control the second touch data, generated from the second input which is sensed by the fingerprint sensing array, to be compensated while the touch sensing array is being driven again before the driving cycle of the touch screen ends.

17. The touch controller of claim 1, further comprising a controller configured to drive the touch sensing array and the fingerprint sensing array,
wherein, while the controller drives the touch sensing array to sense the first input or the second input, the controller floats the fingerprint sensing array.

18. The touch controller of claim 1, further comprising a controller configured to drive the touch sensing array and the fingerprint sensing array,
wherein, while the controller drives one of the touch sensing array and the fingerprint sensing array to sense the first input or the second input, the controller does not drive the other of the touch sensing array and the fingerprint sensing array to sense the first input or the second input.

19. The touch controller of claim 1, wherein the touch sensing array comprises a plurality of touch sensing units arranged in a matrix form, and the fingerprint sensing array comprises a plurality of fingerprint sensing units arranged in the matrix form, and
wherein the fingerprint sensing array is disposed above or below the touch sensing array at at least one area of the touch sensing area.

20. A fingerprint controller for driving a fingerprint sensing array connectable to a touch controller and a touch screen on which a touch sensing area and a fingerprint sensing area are provided, the fingerprint controller comprising:
a controller configured to generate first touch data from a first input on the fingerprint sensing area sensed by the fingerprint sensing array, transmit the first touch data to the touch controller, and generate fingerprint data from a fingerprint input on the fingerprint sensing area,
wherein the first touch data is used by the touch controller to generate position data of the first input on the touch screen. cm 21. The fingerprint controller of claim 20, wherein the controller is configured to generate the first touch data according to a control signal of the touch controller.

22. The fingerprint controller of claim 20, wherein the fingerprint sensing array comprises a plurality of fingerprint sensing units, and
wherein the first touch data comprises touch values generated in a unit of a reference number of the fingerprint sensing units which is set based on a difference of sensing resolution between the fingerprint sensing array and a touch sensing array controlled by the touch controller.

23. The fingerprint controller of claim 22, wherein the controller is configured to float the fingerprint sensing units when the touch controller drives the touch sensing array to generate second touch data from a second input on the touch sensing array.

24-27. (canceled)

28. A touch screen device comprising:
a touch screen comprising a touch sensing area and a fingerprint sensing area;
a touch sensing array configured to sense a first input on at least one of the touch sensing area and the fingerprint sensing area in a touch sensing mode;
a fingerprint sensing array disposed above or below the touch sensing array, configured to sense a second input on the fingerprint sensing area in the touch sensing mode, and configured to sense a third input on the fingerprint sensing area to generate a fingerprint image in a fingerprint sensing mode; and
a processor configured to drive the touch sensing array and the fingerprint sensing array, generate first touch data from the first input, and generate second touch data from the second input,
wherein the first touch data and the second touch data are used to calculate first input coordinates of the first input and second input coordinates of the second input on the touch screen.

29. The touch screen device of claim 28, wherein the processor compensates the first touch data generated from the first input on the fingerprint sensing area, by applying a gain or an offset of the touch sensing array or the fingerprint sensing array to touch values included in the first touch data generated from the first input on the fingerprint sensing area, based on the second touch data, or compensate the second touch data by applying the gain or the offset to touch values included in the second touch data, and
wherein the compensated first touch data and the compensated second touch data are used to calculate the second input coordinates.

30. The touch screen device of claim 28, wherein the touch sensing array comprises a plurality of touch sensing units arranged in a matrix form, and the fingerprint sensing array comprises a plurality of fingerprint sensing units arranged in the matrix form,
wherein two or more fingerprint sensing units are disposed vertically above or below one touch sensing unit,
wherein the second touch data comprises touch values generated in a unit of a reference number of the fingerprint sensing units which is set based on a touch pitch of the touch sensing units and a fingerprint pitch of the fingerprint sensing units.

31-39. (canceled)
